(19) United States
(12) Patent Application Publication
(10) Pub. No.: US 2025/0301413 A1
(43) Pub. Date: Sep. 25, 2025

(54) POWER CONTROL SERVICE

(71) Applicant: Verizon Patent and Licensing Inc., Basking Ridge, NJ (US)

(72) Inventors: Shuang Echo Yang, Naperville, IL (US); Susan Wu Sanders, Bridgewater, NJ (US); Xin Wang, Morris Plains, NJ (US)

(21) Appl. No.: 18/609,080

(22) Filed: Mar. 19, 2024

(51) Int. Cl. H04W 52/24; H04W 52/14

(52) U.S. Cl. CPC H04W 52/243; H04W 52/146

(57) ABSTRACT

A method, an end device, and a non-transitory computer-readable storage medium are described in relation to a power control service. The power control service may include identification of an end device that contributes to interference based on positioning information of the end device. The power control service may calculate and transmit a reduced transmit power value to the end device. The power control service may calculate the reduced transmit power value based on an application service used by the end device.

### BACKGROUND

Development and design of networks present certain challenges from a network-side perspective and an end device perspective. For example, Next Generation (NG) wireless networks, such as Fifth Generation New Radio (5G NR) networks are being deployed and are under continuous development. End devices may connect to a radio access network (RAN) according to several types of configurations and may be afforded different quality of service (QoS) levels.

### BRIEF DESCRIPTION OF THE DRAWINGS

FIG. 1 is a diagram illustrating an exemplary environment in which an exemplary embodiment of a power control service may be implemented;

FIGS. 2A-2C are diagrams illustrating an exemplary process of an exemplary embodiment of the power control service may be implemented;

FIG. 3 is a diagram illustrating exemplary components of a device that may correspond to one or more of the devices illustrated and described herein; and

FIG. 4 is a flow diagram illustrating an exemplary process of an exemplary embodiment of the power control service.

### DETAILED DESCRIPTION

The following detailed description refers to the accompanying drawings. The same reference numbers in different drawings may identify the same or similar elements. Also, the following detailed description does not limit the invention.

In a wireless network, such as a 5G NR network, the transmitting power for channels, such as a Physical Uplink Shared Channel (PUSCH), a Physical Uplink Control Channel (PUCCH), and a Physical Random Access Channel (PRACH), and communication mechanisms, such as Sounding Reference Signal (SRS), and the like, may be determined by a radio access network (RAN) device. For example, depending on the channel and/or communication mechanism, the RAN device may calculate an uplink transmit power value based on a downlink (DL) pathloss estimation, a Target Base Rx Power, and/or other parameters, such as a resource block (RB) factor, a power control command factor, a modulation and coding scheme (MCS) factor, a user equipment (UE) Tx Power, and/or another type of a parameter.

Transmit power control (TPC) may be used in the management of interference. For example, the interference may relate to inter-cell interference, intra-cell interference, uplink interference, remote interference, and/or another type of interference. As a part of addressing interference, the gNB or other type of RAN device (e.g., distributed unit (DU), centralized unit (CU), evolved Node B (eNB), etc.) may need to identify the source of any interference, such as end device(s) contribution to the interference, and to adjust the transmit power of such end device(s) accordingly.

The ability of the RAN device to identify the end device(s) contributing to interference is a complex problem. Additionally, a current limitation of transmit power control is that the adjustment for transmit power control may be subject to a power ramping step size. Thus, if there is a significant power control adjustment to be made, there will be a notable delay to achieve the target power control value compared with tuning on p0 (e.g., a nominal power, etc.) directly by an end device. Thus, inaccurate identification of the end device(s) and subsequent adjustment of transmit power may cause sub-optimal management of interference as well as negatively impact various quality of service (QoS) metrics (e.g., throughput, packet error rate, etc.).

According to exemplary embodiments, a power control service is described. According to an exemplary embodiment, the power control service may be applied to transmission of data via channels of a wireless network, such as a PUSCH, a PUCCH, a PRACH, and/or other types of control plane and/or user plane channels, by an end device. According to an exemplary embodiment, the power control service may be applied to transmission of data pertaining to channel optimization mechanisms, such as SRS, channel state information (CSI) reporting, and the like. According to an exemplary embodiment, the power control service may be applied to 5G wireless networks, legacy wireless networks (e.g., Fourth Generation (4G) networks, Third Generation (3G) networks), etc.), and future generation wireless networks (e.g., Sixth Generation (6G), Seventh Generation (7G), and so forth). According to an exemplary embodiment, the power control service may pertain to transmit power in the uplink from an end device to a RAN device.

According to an exemplary embodiment, the power control service may include artificial intelligence and/or machine learning (AI/ML) logic configured to identify an end device whose transmit power is to be set by the power control service. For example, the AI/ML logic may select the end device based on positioning and/or location information of the end device, as described herein. According to various exemplary embodiments, the power control service may be implemented proactively, reactively, or both. For example, the power control service may relate to a current interference (e.g., reactive) or an anticipated interference (e.g., proactive). According to various exemplary embodiments, the power control service may adjust the transmit power of an end device that may be causing interference to a RAN device, which provides radio access to such end device, or an end device that may be causing interference to a neighboring RAN device, for which the RAN device provides radio access, as described herein.

According to an exemplary embodiment, the identification of the end device may relate to an end device that is prospectively establishing or establishing a wireless connection with the RAN device. According to another exemplary embodiment, the identification of the end device may relate to an end device that is currently attached or connected. For example, the end device may be attached to the RAN, the RAN and a core network and/or an application service layer network, participating in a packet data unit (PDU) application service session, and so forth.

According to an exemplary embodiment, the power control service may include calculation of a power control value, as described herein. For example, the power control service may calculate an uplink (UL) transmit power value for the identified end device. According to an exemplary embodiment, the power control value may be implemented as transmit power control value pertaining to transmissions of data via a channel (e.g., PUSCH, PUCCH, etc.), a channel optimization mechanism (e.g., transmit power for SRS, etc.), and the like, as described herein.

According to an exemplary embodiment, the power control service may calculate the power control value based on an application service used or prospectively to be used by the end device, as described herein. For example, the power control service may be configured to accommodate a particular UL signal-to-noise-ratio (SINR) value or UL SINR range associated with the application service.

According to an exemplary embodiment, the power control service may include AI/ML logic configured to calculate the power control value based on a given set of input parameters. For example, depending on the channel of relevance or channel optimization mechanism, the power control service may use various parameters, such as DL pathloss estimation, Target Base Rx Power, MCS factor, RB factor, power control command, maximum output power for end device, and/or other known parameters. The power control service may also consider other factors, such as positioning information, mobility information of the end device (e.g., speed, velocity, direction relative to the access device), and/or other parameters (e.g., known sources or potential sources of interference based on positioning information, etc.), as described herein.

According to an exemplary embodiment, the power control service may transmit the UL transmit power control value to the end device. For example, the power control value may be transmitted via a Radio Resource Control (RRC) message, a system information block (SIB) message, or another type of control plane message, as described herein.

In view of the foregoing, the power control service may improve network performance in the UL and/or DL (e.g., capacity, throughput, etc.), reduce or eliminate current or prospective interference relating to communications between an end device and a RAN device of a RAN, and provide application service-specific power control, as described herein. For example, the power control service may set uplink transmit power values for prospectively connected end devices when currently connected end devices are experiencing interference. According to another example, the power control service may adjust uplink transmit power values in a manner that mitigates network performance imbalances in the UL and the DL.

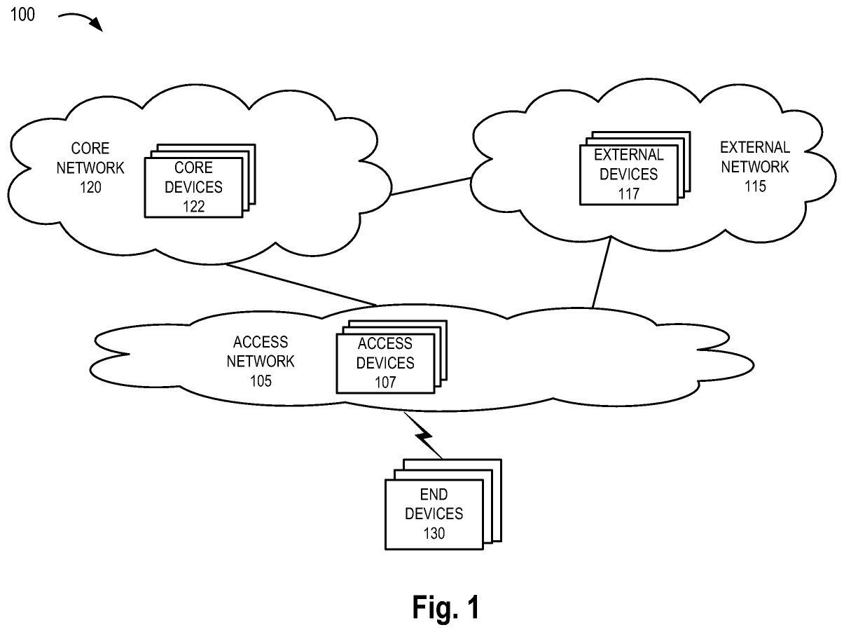

FIG. 1 is a diagram illustrating an exemplary environment 100 in which an exemplary embodiment of the power control service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the power control service may use at least one of these planes of communication.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., radio access technologies (RATs), etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. According to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a gNB, an enhanced Long Term Evolution (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access customer premises equipment (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to an exemplary embodiment, at least some of access devices 107 include logic of the power control service, as described herein. For example, a gNB, an eNB, a RIC, a future generation wireless station, a DU, a CU, or the like may include logic of the power control service, as described herein.

External network 115 may include one or multiple networks of one or multiple types and technologies that provide an end device application service. For example, external network 115 may be implemented using one or multiple technologies including network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of end device application services. For example, the end device application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) network of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM), a unified data repository (UDR), an authentication server function (AUSF), a security anchor function (SEAF), a network exposure function (NEF), a network slice selection function (NSSF), a network repository function (NRF), a policy control function (PCF), a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

End device 130 may include a device that may have computational and communication capabilities (e.g., wireless, wired, optical, etc.). End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, or another type of UE.

End device 130 may be configured to execute various types of software (e.g., applications, programs, etc.). The number and the types of software may vary among end devices 130. For example, end device 130 may host one or multiple end device applications that may relate to various types of application services described in relation to external devices 117. For example, the end device application may pertain to IoT, extreme real-time communications, gaming, voice, video-calling, navigation, ultra-reliable communications, and so forth. The end device application may include a client-side application.

End device 130 may include “edge-aware” and/or “edge-unaware” application service clients. For purposes of description, end device 130 is not considered a network device. End device 130 may be implemented as a virtualized device in whole or in part.

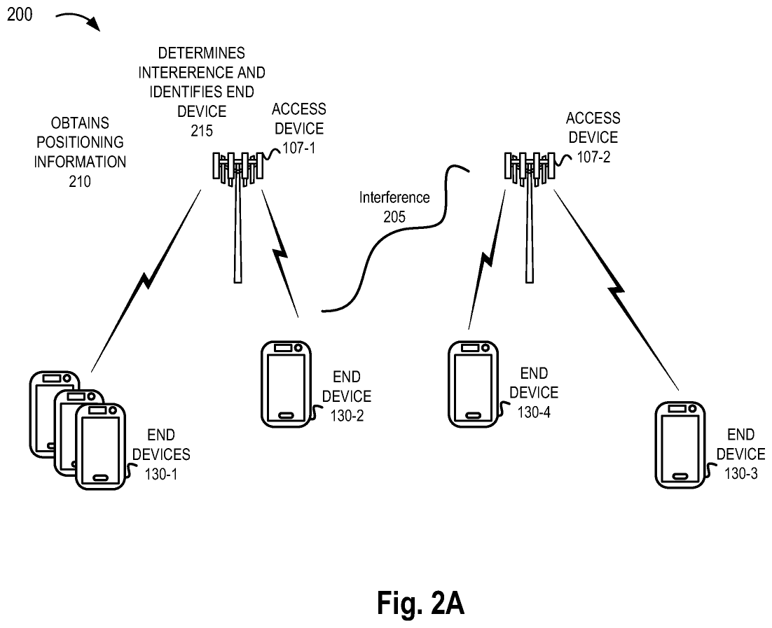

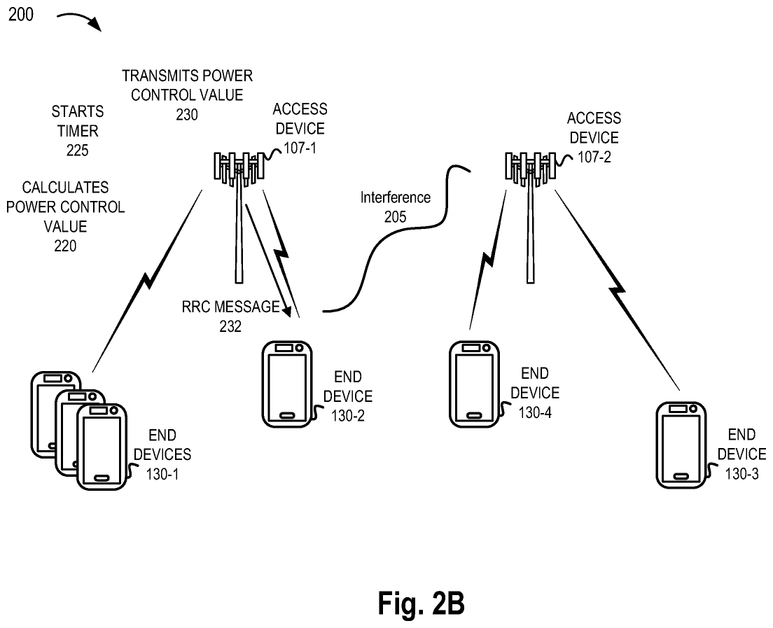

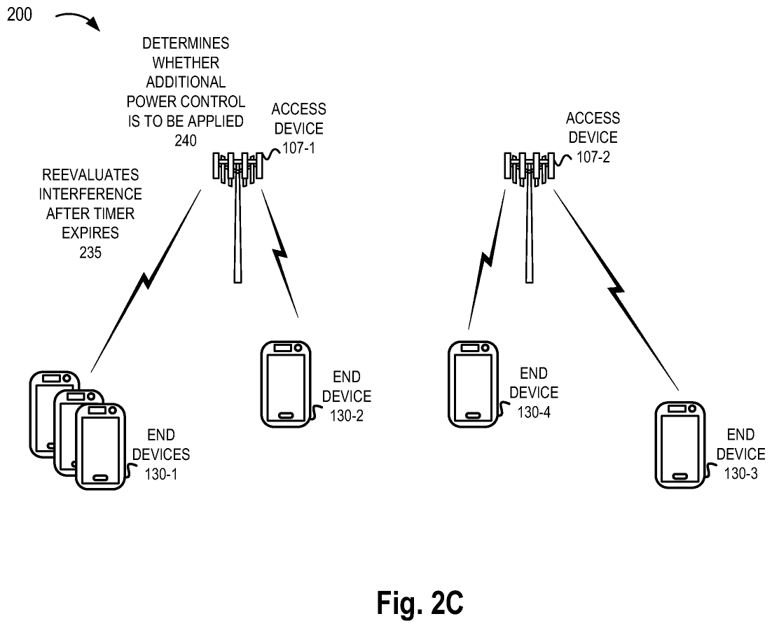

FIGS. 2A-2C are diagrams illustrating another exemplary environment and an exemplary process 200 of an exemplary embodiment of the power control service. As illustrated, environment includes access devices 107-1 and access device 107-2 (also referred to collectively as access devices 107 and individually or generally as access device 107). According to this exemplary scenario, access device 107 may be implemented as a gNB, a DU, a CU, or a future generation wireless station, for example. As further illustrated, environment includes end devices 130-1, end device 130-2, end device 130-3, and end device 130-4 (also referred to collectively as end devices 130 and individually or generally as end device 130). The number and arrangement of access devices 107 and end devices 130 are exemplary.

According to an exemplary embodiment, access device 107 may obtain or calculate positioning information of end device 130. The positioning information may include a historical, a current, and/or a prospective location of end device 130. The positioning information may include other information like end device mobility, such as speed, velocity, altitude, azimuth, and the like. According to some exemplary embodiments, access device 107 may obtain or calculate positioning information in conjunction with another network device, which is not illustrated (e.g., a location management function (LMF), a third party network device, or the like). According to some exemplary embodiments, access device 107 may use (DL) positioning reference signals (PRS) and/or (UL) SRSs to obtain or calculate the position of end device 130.

According to other exemplary embodiments, other known techniques or mechanisms may be implemented, such as satellite positioning (e.g., Global Positioning System (GPS), Differential GPS (DGPS), Galileo, etc.), cellular positioning (e.g., triangulation, Enhanced Observed Time Difference (E-OTD), Uplink Time Difference of Arrival (U-TDOA), assisted GPS, and indoor positioning (e.g., Wireless Local Area Network (WLAN) positioning, Bluetooth positioning, IEEE 802.11 positioning, UWB positioning, indoor positioning with GPS, etc.), tracking area update (TAU) procedure, registration area (RA) procedure, and/or the like. These technologies may provide positioning information (e.g., geographic coordinates and/or other aspects of position, location, end device mobility, etc.) with different degrees of precision or accuracy. End device 130 may have location-aware capability, or both location-aware and navigational capabilities, which may be used to obtain or calculate positioning information, as described herein. According to various exemplary embodiments, the positioning of end device 130 may relate to indoors and/or outdoors.

Access device 107 may also store (or have remote access to) network topology information that may indicate placement of a network device according to geographic coordinates (e.g., latitude/longitude values, azimuth values) of a geographic coordinate system (GCS), or coordinate values associated with another type of coordinate system (e.g., a projected coordinate system (PCS), etc.). The network topology information may include map information. The network topology information may include Voronoi-based area (e.g., a cell, a sector, a zone/sub-sector, etc.), geo-bin area, and/or another division of a geographic area representative of radio coverage, network service coverage, and the like, in relation to access device 107 and neighboring access device(s) 107. Access device 107 may store (or have remote access to) other types of network information that may correlate to the network topology information, such as network device identifiers, network device profile information (e.g., type of access device 107, attribute information, etc.), and so forth.

In relation to FIGS. 2A-2C, access device 107-1 may store network topology information relating to access device 107-2, and vice versa. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the type of the RAN device (e.g., eNB versus gNB, etc.), attributes of the RAN device (e.g., antenna configuration, radio frequency band of beam, etc.), and/or other factors (e.g., terrain of the radio covered locale).

Referring to FIG. 2A, according to an exemplary scenario, assume that end device 130-2 is connected to access device 107-1 and has a configured transmit power for data transmissions via a PUSCH that causes interference 205 to a cell of access device 107-2. According to some exemplary embodiments, access device 107-2 may communicate with access device 107-1 (not shown) indicating interference. For example, an exemplary message may include a network identifier of access device 107-2, data indicating interference, and other correlated information (e.g., identifier of an antenna, frequency or carrier information, type of channel via which interference was detected, etc.). According to an exemplary embodiments, access device 107-1 may proactively determine the interference, as described further below. For example, as further illustrated, access device 107-2 may obtain positioning information relating to end devices 130-1 and end device 130-2. According to some exemplary scenarios, the proactive determination of interference may be responsive to the message from access device 107-2. According to other exemplary scenarios, the proactive determination of interference may be independent of receiving a message from a neighboring access device 107, such as access device 107-2. For example, access device 107-2 may continuously, periodically, or the like, evaluate current or prospective conditions of interference.

Based on the positioning information and current transmit power control values associated with each end device 130, and network topology information, access device 107-1 may determine that end device 130-2 is causing interference 205 to a cell (e.g., carrier frequency, radio band, or the like) of access device 107-2. For example, the AI/ML logic of access device 107-1, which includes the power control service may determine which end device(s) 130 that contribute to the interference. For example, the AI/ML logic may include a model that includes an algorithm that uses correlations between learned variables and values (also referred to as power control information), which may include end device positioning information, current transmit powers and, interference probability values (e.g., 0 to 1) and/or interference values (e.g., 0 or 1). The model may include other correlations pertaining to network topology information, carrier frequencies, attributes of RAN devices, and the like, which may be stored and correlated with the power control information, as described herein. The AI/ML logic may apply the positioning information and current transmit power value of end device 130 to the power control information, and select end device 130 as a candidate end device 130 that may contribute to the interference based on an analysis of such information. For example, the AI/ML logic may determine that a radio coverage area (e.g., a geo-bin) of access device 107-1 at which end device 130 is situated, has a current transmit power that exceeds a permissible transmit power and likely would cause interference to access device 107-2.

The AI/ML logic may include learning-based and/or intelligence logic, such as reinforcement-based learning, unsupervised learning, semi-supervised learning, supervised learning, deep learning, artificial intelligence, and/or other types of device intelligence. The model may include one or multiple types of models. For example, the model may include a time series model, a forecast model, a clustering model, and/or a classification model. The model may include a tree-based algorithm, a regressive algorithm, and/or another type of AI/ML algorithm or logic, such as Naïve Bayes, K-Nearest Neighbors, decision tree, Random Forest, gradient boosting, support vector machine, clustering via embedding, a dense neural network, a convolutional neural network, a recurrent neural network, and/or the like.

Referring to FIG. 2B, in response to receiving the message from access device 107-2 or the proactive determination of interference, access device 107-1 may calculate a power control value for the identified end device 130 (e.g., end device 130-2). For example, the power control value for the PUSCH may be implemented as a p0-nominalWithGrant value or another suitable UL transmit power value. The power control value may be a reduced or lower power control value relative to the (current) power control value of end device 130-2. According to some exemplary embodiments, access device 107-1 may calculate the power control value based on the application service used by end device 130-2. For example, access device 107-1 may adjust the current transmit power so that an UL SINR value, an interference value, a noise and interface value, or the like associated with the application service may be afforded. Access device 107-1 may identify or determine the application service based on packet inspection and/or context information (e.g., end device identifier correlated to application service) associated with end device 130-2.

Access device 107-1 may also start a timer. For example, the timer may be an interference hysteresis timer that affords an allotted time period for the reduced power control value to take effect in eliminating interference 205. As further illustrated, access device 107-1 may transmit 230 the power control value to end device 130-2 via an RRC message 232. For example, RRC message 232 may be implemented as an RRC Connection Reconfiguration message. According to this exemplary scenario, access device 107-1 may not change the power control values for end devices 130-1.

Referring to FIG. 2C, upon expiration of the timer, access device 107-1 may reevaluate 235 interference. For example, access device 107-1 may reevaluate positioning information and current power control values of end devices 130-1 and end device 130-2. Additionally, or alternatively, access device 107-2 may transmit a message (not illustrated) to access device 107-1 indicating no more interference, or the absence of receiving a message may be indicative of no more interference. Based on the result of the evaluation, access device 107-1 may determine whether additional power control is to be applied 240. According to this exemplary scenario, assume that access device 107-1 determines that there is no interference.

FIGS. 2A-2C illustrate an exemplary process 200 of the power control service, however, according to other exemplary embodiments, the power control service may perform additional operations, fewer operations, and/or different operations than those illustrated and described in relation to FIGS. 2A-2C. For example, according to other exemplary scenarios, end device 130-2 may cause interference to end devices 130-1, or one or more of end devices 130-1 may cause interference to end device 130-2. Access device 107-1 may perform similar steps or operations associated with process 200, as described herein, to eliminate the interference.

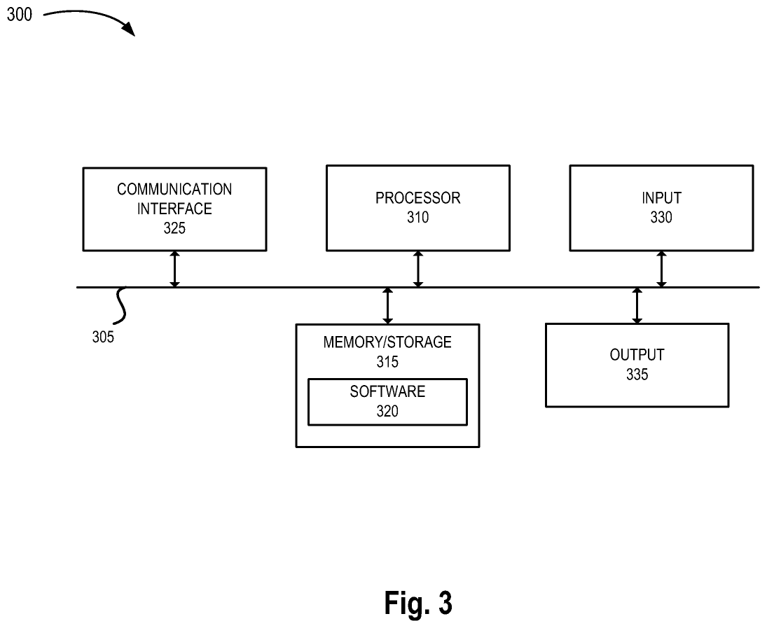

FIG. 3 is a diagram illustrating exemplary components of a device 300 that may be included in one or more of the devices described herein. For example, device 300 may correspond to access device 107, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to access device 107, software 320 may include an application that, when executed by processor 310, provides a function and/or a process of the power control service, as described herein. Software 320 may also include firmware, middleware, microcode, hardware description language (HDL), and/or another form of instruction. Software 320 may also be virtualized. Software 320 may further include an operating system (e.g., Windows, Linux, Android, proprietary, etc.), such as operating system 204. Software 320 may include applications, libraries, AI/ML models, and the like.

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a function, an operation, or a process described herein. Alternatively, for example, according to other implementations, device 300 may be configured to perform a function, an operation, or a process described herein based on the execution of hardware (processor 310, etc.).

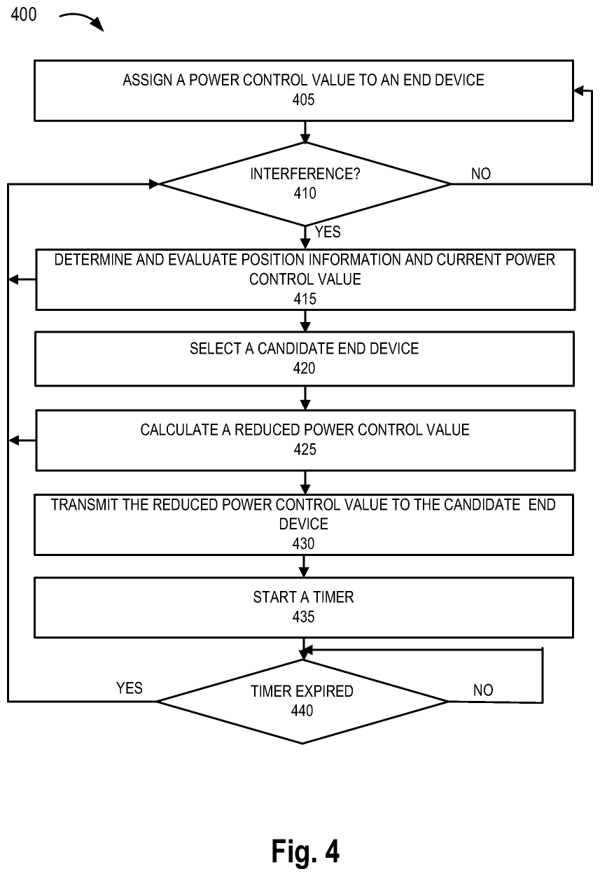

FIG. 4 is a flow diagram illustrating an exemplary process 400 of an exemplary embodiment of the power control service. According to an exemplary embodiment, access device 107 may perform steps of process 400. According to an exemplary implementation, a processor may execute software to perform a step (in whole or in part) of process 400, as described herein. Alternatively, a step (in whole or in part) may be performed by execution of only hardware.

In block 405, access device 107 may assign a power control value to an end device 130. For example, access device 107 may assign the power control value to end device 130 relating to various channels (e.g., PUSCH, PRACH, etc.) and for a communication mechanism (e.g., SRS, etc.), as described herein. According to some exemplary embodiments, the power control value may correspond to a power control variable or information element (IE) of a network standard (e.g., 3GPP, etc.), such as a p0-NominalWithGrant value, a p0-NominalWithoutGrant value, preambleReceivedTargetPower value, an SRS power control value, and so forth. According to some exemplary embodiments, for purposes of description of process 400, the power control value of block 405 may be implemented as a default power value (e.g., a default UL transmit power value). According to various exemplary embodiments, the power control value may be implemented at a per end device level (e.g., single end device), at a cell level, at an end device group level (e.g., multiple end devices), and the like.

In block 410, access device 107 may determine whether there is interference. For example, access device 107 may or may not detect noise, interference, noise and interference at access device 107 based on the received transmissions from end device(s) 130 and comparisons to a noise threshold value, an interference threshold value, a noise and interference threshold value, etc. According to another example, access device 107 may or may not receive (from another access device 107, such as a neighbor access device 107), a message indicating interference.

When access device 107 determines there is no interference (block 410—NO), process 400 may return to block 405. When access device 107 determines that there is interference (block 410—YES), access device 107 may determine and evaluate position information and current power control value (block 415). For example, the AI/ML logic of access device 107 may analyze current and/or prospective position information associated with end device 130, current power control value, and other correlated information (e.g., interference probability value, interference value, network topology information, etc.), as described herein. According to an exemplary embodiment, according to some exemplary scenarios, process 400 may return to block 410 (as illustrated in FIG. 4). For example, when the current power control value of end device 130 may be equal to a lower bound or an upper bound of power control value adjustment (e.g., a minimum transmit power value or a maximum transmit power value), access device 107 may determine that no further adjustment should be performed on end device(s) 130 and return to block 410.

In block 420, access device 107 may select a candidate end device 130. For example, based on the analysis, the AI/ML logic may select one or multiple candidate end devices 130 that may contribute to the interference. According to some exemplary embodiments, the AI/ML logic may select one or multiple candidate end devices 130 that may be subject to the interference.

In block 425, access device 107 may calculate a reduced power control value. For example, depending on the channel, access device 107 may use different parameters and values to calculate the reduced power control value, as described herein. Access device 107 may also calculate the reduced power control value based on the application service, as described herein. According to some exemplary embodiments, access device 107 may calculate an increased power control value. For example, in block 420, access device 107 may select candidate end device(s) 130 that may be subject to interference (based on the AI/ML logic) and calculate the increased power control value. According to some exemplary embodiments, access device 107 may elect to not adjust the power control value (i.e., process 400 returns to block 410) because such an adjustment may degrade performance for candidate end device 130. According to another example, access device 107 may identify a significant number of candidate end devices 130, which may make power control value adjustment impractical. According to such a scenario, access device 107 may be configured to return to block 410 instead of calculating a power control value in block 425.

In block 430, access device 107 may transmit the reduced power control value to end device 130. For example, access device 107 may transmit the reduced power control value via an RRC message or a SIB message depending on the candidate end device 130 (e.g., attached end devices 130, end devices 130 that may prospectively attach in a given area, etc.), as described herein. According to an exemplary embodiment, access device 107 may transmit the increased power control value to end device 130 in a similar manner (e.g., an RRC message, a SIB message, etc.).

In block 435, access device 107 may start a timer. For example, access device 107 may allot a time period to enable adjustment of the current transmit power for each candidate end device 130 and for the adjustment to take effect on the interference (e.g., mitigate the interference).

In block 440, access device 107 may determine whether the timer has expired. When access device 107 determines that the timer has not expired (block 440—NO), access device 107 may return to block 440.

When access device 107 determines that the timer has expired (block 440—YES), process 400 may return to block 410. For example, access device 107 may determine whether there is interference.

FIG. 4 illustrates an exemplary process 400 of the power control service, however, according to other exemplary embodiments, the power control service may perform additional operations, fewer operations, and/or different operations than those illustrated and described in relation to FIG. 4. For example, according to other exemplary embodiments of the power control service, block 405 may be omitted.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/of” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 4, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
determining, by a network device, an uplink interference;
determining, by the network device in response to the uplink interference, position information of an end device;
determining, by the network device based on the position information, that the end device contributes to the uplink interference;
calculating, by the network device, a reduced uplink transmit power value relative to a current uplink transmit power of the end device; and
transmitting, by the network device to the end device, the reduced uplink transmit power value.

2. The method of claim 1, wherein determining that the end device contributes to the uplink interference comprises:
storing, by the network device, power control information that includes network topology information and interference information; and
applying, by the network device, the positioning information and the current uplink transmit power of the end device to the power control information.

3. The method of claim 2, wherein the interference information includes at least one of an interference probability value or an interference value.

4. The method of claim 1, wherein the uplink interference is a prospective interference.

5. The method of claim 1, further comprising:
starting, by the network device in response to the transmitting, a timer which upon expiration, interference is reevaluated.

6. The method of claim 1, wherein the calculating comprises:
calculating, by the network device, the reduced uplink transmit power value based on an application service the end device is using via an uplink channel of the network device.

7. The method of claim 1, wherein the uplink interference pertains to an uplink of a neighboring network device or an uplink of the network device.

8. The method of claim 1, wherein the network device comprises a next generation Node B, a centralized unit (CU), or a distributed unit (DU) of a radio access network.

9. A network device comprising:
a processor, wherein the processor is configured to:
determine an uplink interference;
determine, in response to the uplink interference, position information of an end device;
determine, based on the position information, that the end device contributes to the uplink interference;
calculate, a reduced uplink transmit power value relative to a current uplink transmit power of the end device; and
transmit, to the end device, the reduced uplink transmit power value.

10. The network device of claim 9, wherein, determining that the end device contributes to the uplink interference, the processor is further configured to:
store power control information that includes network topology information and interference information; and
apply the positioning information and the current uplink transmit power of the end device to the power control information.

11. The network device of claim 10, wherein the interference information includes at least one of an interference probability value or an interference value.

12. The network device of claim 9, wherein the uplink interference is a prospective interference.

13. The network device of claim 9, wherein the processor is further configured to:
start, in response to the transmission of the reduced uplink transmit power value, a timer which upon expiration, interference is reevaluated.

14. The network device of claim 9, wherein the uplink interference pertains to an uplink of a neighboring network device or an uplink of the network device.

15. The network device of claim 9, wherein the processor is further configured to:
calculate the reduced uplink transmit power value based on an application service the end device is using via an uplink channel of the network device.

16. The network device of claim 9, wherein the network device comprises a next generation Node B, a centralized unit (CU), or a distributed unit (DU) of a radio access network.

17. A non-transitory computer-readable storage medium storing instructions executable by a processor of a network device, wherein the instructions are configured to:
determine an uplink interference;
determine, in response to the uplink interference, position information of an end device;
determine, based on the position information, that the end device contributes to the uplink interference;
calculate, a reduced uplink transmit power value relative to a current uplink transmit power of the end device; and
transmit, to the end device, the reduced uplink transmit power value.

18. The non-transitory computer-readable storage medium of claim 17, wherein the instructions are further configured to:
store power control information that includes network topology information and interference information; and
apply the positioning information and the current uplink transmit power of the end device to the power control information.

19. The non-transitory computer-readable storage medium of claim 17, wherein the uplink interference is a prospective interference.

20. The non-transitory computer-readable storage medium of claim 17, wherein the instructions are further configured to:
calculate the reduced uplink transmit power value based on an application service the end device is using via an uplink channel of the network device.
